(19) United States
(12) Patent Application Publication
(10) Pub. No.: US 2006/0006035 A1
(43) Pub. Date: Jan. 12, 2006

(54) Case with tab protector

(76) Inventor: Joseph Liang, Ping-Tung Hsien (TW)

Correspondence Address: FROMMER LAWRENCE & HAUG, 745 FIFTH AVENUE- 10TH FL., NEW YORK, NY, 10151, US

(21) Appl. No.: 10/886,984

(22) Filed: Jul. 8, 2004

(51) Int. Cl. A45C 13/18; A45C 13/10; H01R 13/62

(52) U.S. Cl. 190/101; 190/120

(57) ABSTRACT

A case includes a first shell having a first peripheral portion, and a second shell having a second peripheral portion connected movably to the first peripheral portion of the first shell. A slide fastener includes a pair of tape parts secured to the first and second peripheral portions of the first and second shells, respectively, interlocking elements provided on the tape parts, a pair of slider elements movably provided on the tape parts and operable for engaging and disengaging the interlocking elements, and a pair of pull tabs pivoted to the slider elements, respectively. A tab protector is mounted on the first shell, and cooperates with the first shell to form a tab-insertion space for insertion of the pull tabs of the slide fastener therein.

### BACKGROUND OF THE INVENTION

1. Field of the Invention

The present invention relates to a case, more particularly to a case including a tab protector.

2. Description of the Related Art

Referring to FIGS. 1 and 2, a conventional case used to store clothes and other personal belongings includes a first shell 1, a second shell 2, and a slide fastener 3 interconnecting the first shell 1 and the second shell 2. The slide fastener 3 includes a pair of tape parts 305 fixed to opposing peripheral areas of the first shell 1 and the second shell 2, respectively. Interlocking elements 301 are provided on the tape parts 305, and two sliders 302 are movably provided on the tape parts 305. The sliders 302 operate to effect engaging and disengaging of the interlocking elements 301 on the tape parts 305. Further, a pull tab 303 is pivoted to each of the sliders 302. The pull tabs 303 are manipulated by a user to move the sliders 302.

A padlock 4 is often used for security reasons, that is, to prevent undesired opening of the case. In the configuration shown in FIGS. 1 and 2, an opening 304 is formed in a distal end of each of the pull tabs 303, and the padlock 4 is hooked through the openings 304 to thereby secure the pull tabs 303 to each other.

A drawback of the above structure is that the padlock 4 and the pull tabs 303 are easily damaged during transport of the case. If the damage is significant, the padlock 4 may be difficult or impossible to open, and the pull tabs 303 may break loose from their connection to the sliders 302.

In an alternative conventional configuration, with reference to FIG. 3, a combination lock 6 is fixedly mounted to a specific area of the first shell 1 in proximity to the slide fastener 3. The combination lock 6 is adapted to receive the distal ends of the pull tabs 303 to lock onto or release the same. The combination lock 6 includes dials 602 that are manipulated by the user to release the locking mechanism of the combination lock 6. Although such a configuration results in less damage to both the combination lock 6 and the pull tabs 303 (i.e., during transport of the case), the combination lock 6 is complicated in structure, and, as a result, is costly to produce.

### SUMMARY OF THE INVENTION

Therefore, the object of the present invention is to provide a case that is used to store clothes and other personal belongings, that has a simple structure, and that can be manufactured at a relatively low cost. According to the present invention, a case comprises a first shell having a first peripheral portion, and a second shell having a second peripheral portion connected movably to the first peripheral portion of the first shell. A slide fastener interconnects the first and second shells. The slide fastener includes a pair of tape parts secured to the first and second peripheral portions of the first and second shells, respectively, interlocking elements provided on the tape parts, apair of slider elements movably provided on the tape parts and operable for engaging and disengaging the interlocking elements on the tape parts, and a pair of pull tabs pivoted to the slider elements, respectively.

The case further includes at least one tab protector having a pair of fixing end portions fixed to the first shell, and a holding portion that is disposed between the fixing end portions and that cooperates with the first shell to form a tab-insertion space. The tab-insertion space permits insertion of the pull tabs of the slide fastener therein.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional case having a padlock;

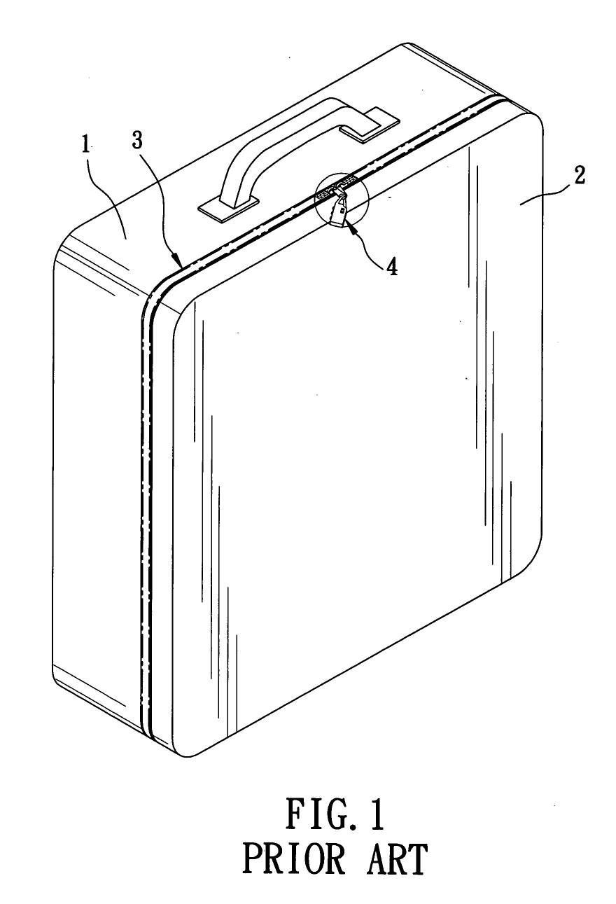

FIG. 2 is a magnified view of the encircled portion of FIG. 1;

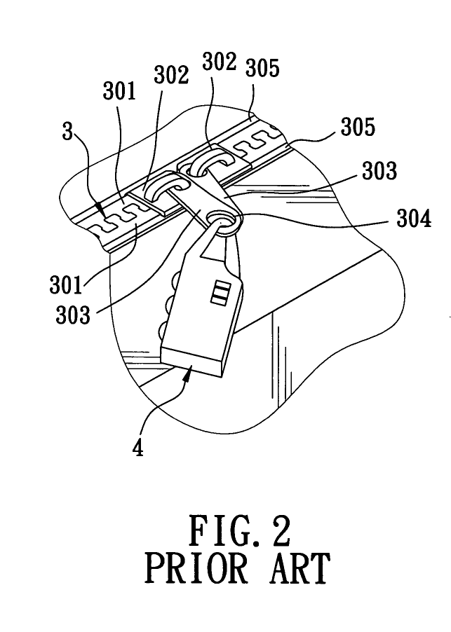

FIG. 3 is a fragmentary perspective view of another conventional case having a combination lock;

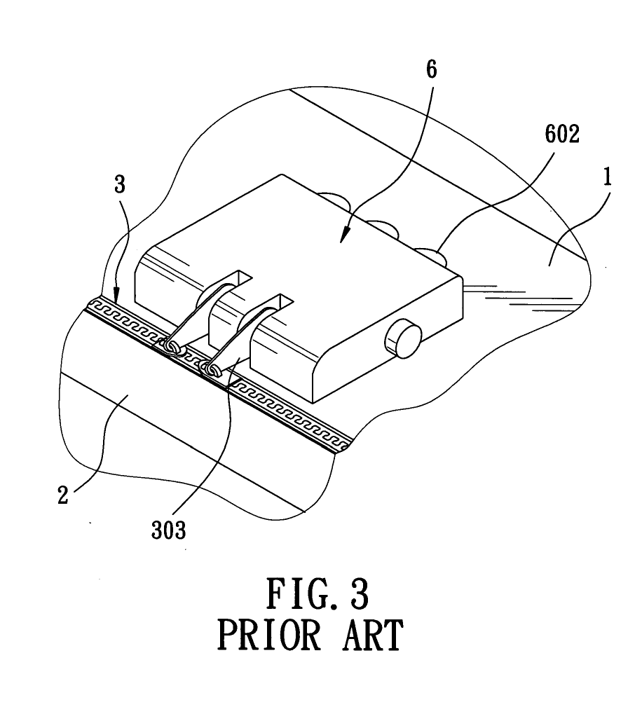

FIG. 4 is a perspective view of a case including a tab protector according to a preferred embodiment of the present invention;

FIG. 5 is a fragmentary perspective view of the preferred embodiment, illustrating pull tabs and a padlock when received in the tab protector; and

FIG. 6 is a fragmentary schematic view of the preferred embodiment, illustrating the pull tabs and the padlock when received in the tab protector.

### DETAILED DESCRIPTION OF THE PREFERRED EMBODIMENTS

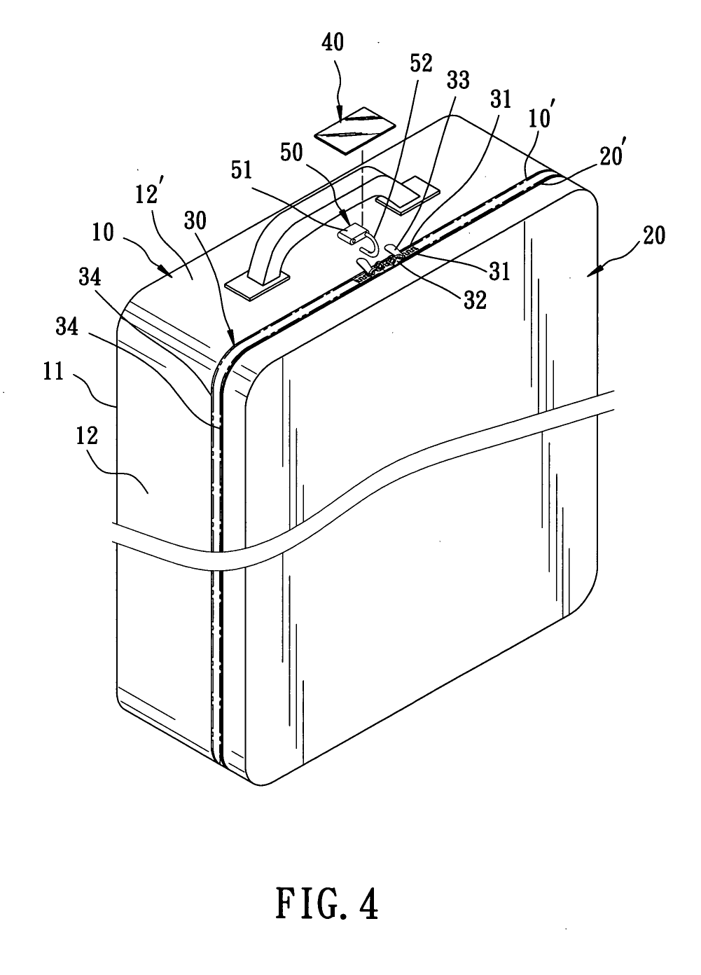

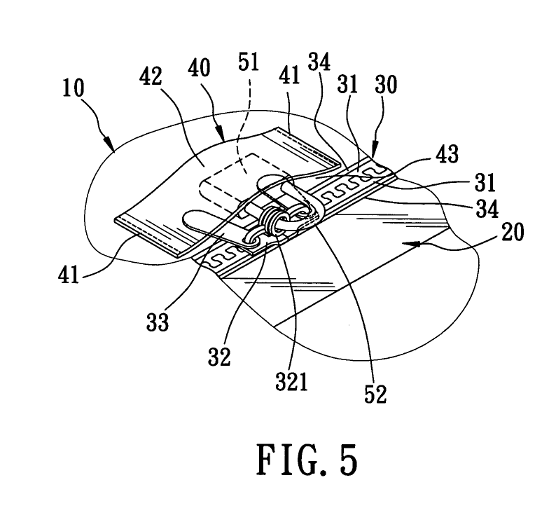

Referring to FIGS. 4 and 5, a case according to a preferred embodiment of the present invention includes a first shell 10, a second shell 20, a slide fastener 30, a tab protector 40, and a padlock 50.

The first shell 10 has a first peripheral portion 10′, and the second shell 20 has a second peripheral portion 20′. The second peripheral portion 20′ of the second shell 20 is connected movably to the first peripheral portion 10′ of the first shell 10. The first shell 10 further includes a side panel 11, and a peripheral panel 12 extending from a periphery of the side panel 11 and formed with the first peripheral portion 10′. The peripheral panel 12 has a top portion 12′.

The slide fastener 30, which is a known double-acting zipper in this embodiment, includes a pair of tape parts 34. The tape parts 34 are secured to the first and second peripheral portions 10′, 20′ of the first and second shells 10, 20, respectively. Interlocking elements 31 are provided on the tape parts 34, and a pair of slider elements 32 is movably provided on the tape parts 34. The slider elements 32 operate to engage and disengage the interlocking elements 31 on the tape parts 34. The slide fastener 30 also includes a pair of pull tabs 33, each of which is pivoted to a respective one of the slider elements 32.

Each of the slider elements 32 includes a pair of locking rings 321 mounted at a predetermined distance from each other with center axes substantially aligned. Further, the locking rings 321 are mounted such that when the slider elements 32 are operated to close the slide fastener 30, the center axes of the locking rings 321 of one of the slider elements 32 are substantially aligned with the center axes of the locking rings 321 of the other of the slider elements 32.

The padlock 50 may be hooked into the locking rings 321 of the slider elements 32. That is, the padlock 50 includes a lock housing 51, and a shackle 52 connected operatively to the lock housing 51 to realize a locking operation of the padlock 50 in a conventional manner. The shackle 52 engages the locking rings 321 of the slider elements 32 to maintain a closed state of the slide fastener 30. In an alternative embodiment, the padlock 50 may be engaged with conventional pull tabs having openings on distal ends thereof.

The tab protector 40 is an elastic and substantially rectangular woven band in the preferred embodiment. The tab protector 40 includes a pair of fixing end portions 41 fixed to the first shell 10, such as by sewing, and a holding portion 42 that is disposed between the fixing end portions 41. The holding portion 42 cooperates with the first shell 10 to form a tab-insertion space 43.

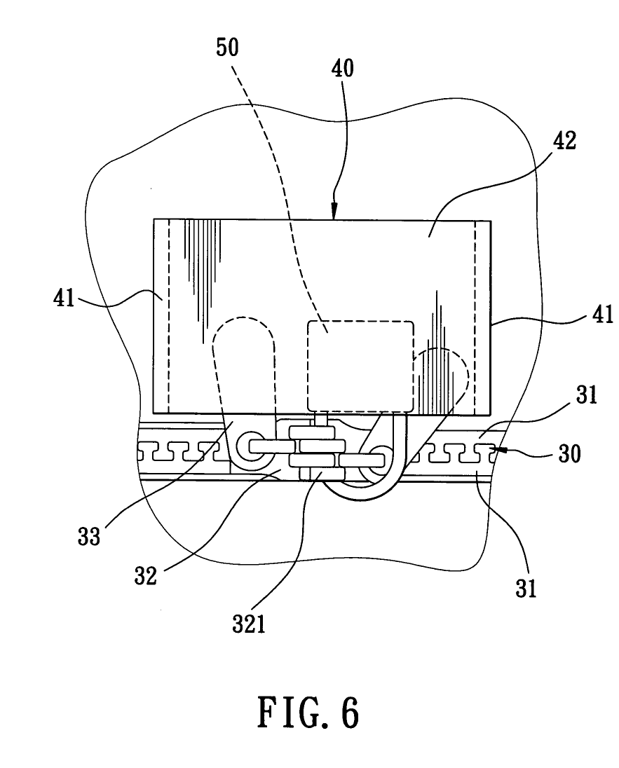

Referring to FIGS. 5 and 6, in a state where the padlock 50 is engaged with the locking rings 321 of the slider elements 32, the pull tabs 33 and the lock housing 51 of the padlock 50 may be received removably in the tab-insertion space 43 formed between the first shell 10 and the holding portion 42 of the tab protector 40. The elasticity of the tab protector 40 further ensures that the pull tabs 33 and the padlock 50 are held firmly in place.

Although the tab protector 40 is shown mounted to an outer surface of the topportion 12′ of the peripheral panel 12 of the first shell 10, it is possible to fix the tab protector 40 to other areas of the peripheral panel 12. Furthermore, a plurality of the protectors 40 may be mounted to the first shell 10 to provide the user with more than one choice as to where the padlock 50 and the pull tabs 33 may be held firmly in place following locking of the padlock 50 onto the slider elements 32.

In view of the foregoing construction, damage to the pull tabs 33 and the padlock 50 during transport of the case can be prevented by the tab protector 40. Furthermore, the tab protector 40 is simple in structure, is easily mounted to the first shell 10, and is inexpensive to produce.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A case comprising:
a first shell having a first peripheral portion;
a second shell having a second peripheral portion connected movably to said first peripheral portion of said first shell;
a slide fastener including
a pair of tape parts secured to said first and second peripheral portions of said first and second shells, respectively,
interlocking elements provided on said tape parts,
a pair of slider elements movably provided on said tape parts and operable for engaging and disengaging said interlocking elements on said tape parts, and
a pair of pull tabs pivoted to said slider elements, respectively; and
at least one tab protector having a pair of fixing end portions fixed to said first shell, and a holding portion that is disposed between said fixing end portions and that cooperates with said first shell to form a tab-insertion space, said tab-insertion space permitting insertion of said pull tabs of said slide fastener therein.

2. The case as claimed in claim 1, wherein said tab protector is formed from an elastic band.

3. The case as claimed in claim 2, further comprising a padlock having a lock housing and a shackle connected operatively to said lock housing, said padlock being operable such that said shackle engages one set of said slider elements and said pull tabs to maintain a closed state of said slide fastener, said lock housing being received removably in said tab-insertion space.

4. The case as claimed in claim 1, wherein said first shell includes a side panel and a peripheral panel extending from a periphery of said side panel, said peripheral panel having a top portion with an outer surface, said tab protector being fixed to said outer surface of said top portion of said peripheral panel.
